(19) United States
(12) Patent Application Publication
(10) Pub. No.: US 2009/0122345 A1
(43) Pub. Date: May 14, 2009

(54) Image forming apparatus

(76) Inventor: KAZUYOSHI TANAKA, TOKYO (JP)

Correspondence Address: FINNEGAN, HENDERSON, FARABOW,;GARRETT & DUNNER, L.L.P., 1300 I Street, N.W., Washington, DC, 20005-3315, US

(21) Appl. No.: 11/907,055

(22) Filed: Oct. 9, 2007

(51) Int. Cl. G06K 1/00; H04N 1/40

(52) U.S. Cl. 358/1.16; 358/471

(57) ABSTRACT

Disclosed is an image forming apparatus including: an image storing section to store input image data; an image outputting section to form and output an image onto a recording medium based on the image data stored in the image storing section; a termination instructing section to instruct a termination of an operation; a display section to display a selection screen for selecting any one of operation items including at least “forcible termination” and “save the current state and termination” when the termination of the operation is instructed on the termination instructing section during an image forming operation in the image outputting section or during a standby state for the image forming operation; an operation section to select any one of the operation items displayed on the selection screen; and a control section to control the operation of the image forming apparatus according to the operation item selected on the operation section.

### BACKGROUND OF THE INVENTION

1. Field of the Invention

The present invention relates to an image forming apparatus equipped with a termination instructing section for a user to instruct a termination of an operation during an image forming operation or during a standby state.

2. Description of Related Art

An image forming apparatus, such as a digital copier and a printer, is sometimes used as a mass printing machine for print on demand (POD) to output several hundreds or several thousands of copies of documents each composed of several hundreds of pages. In such a case, if an image forming operation is forcibly terminated on the way and the power supply is broken (off), the image data and the related data thereof that are stored in a volatile memory are lost. Accordingly, the image data has to be read (transmitted) again, or a user has to set output conditions, the number of remaining copies, and the like once more at the time of the application of electric power. Such operations are troublesome for the user.

Accordingly, for example, Japanese Patent Application Laid-Open Publication No. 2000-250362 describes an image forming apparatus that includes a one-touch job memory key for breaking an image outputting operation. When the one-touch job memory key is pushed down, the image forming apparatus breaks image outputting at the time point of an termination of the imaging of the last sheet of the copy that is now output, and evacuates into a nonvolatile memory the image data, set conditions of the operations related to the image outputting, the number of sheets of an original, the number of output copies, and the data indicating the association with the image data. Thereafter, the image forming apparatus starts a power source breaking operation. Thereby it becomes possible to reassume the image outputting operation even after power re-activation.

Moreover, Japanese Patent Application Laid-Open Publication No. Hei 5-112060 describes an image recording apparatus that evacuates the data under processing into a nonvolatile storage medium when break of the power source is instructed. The image recording apparatus then restores the evacuated data at the time of the application of electric power. Moreover, Japanese Patent Application Laid-Open Publication No. Hei 7-162624 describes an image forming apparatus that stores the image data input to be subjected to an image outputting operation into an internal memory capable of holding the content even when a power source switch is off, if the image forming apparatus detects the occurrence of a trouble which should be settled in the off state of the power source switch thereof. The image forming apparatus then successively performs the image outputting operation of the image data stored in the internal memory after the settlement of the trouble.

However, because an image forming job is forcibly terminated even during its execution when a user performs an operation to instruct a power source break, such as the turning-off of the power source switch, by the technique of Japanese Patent Application Laid-Open Publication No. 2000-250362, the job cannot be resumed from the point where the job was broken when the power source switch is operated next time to activate the power source, and the user has to read (transmit) of the image data again and has to set the output condition thereof, the number of remaining copies, and the like. The operations are troublesome.

Moreover, the technique of Japanese Patent Application Laid-Open Publication No. Hei 5-112060 has the following problem. Although the technique is to evacuate the data under processing into the nonvolatile recording medium at the time of receiving an instruction of a power source break, the power source thereof is not readily turned off owing to the execution of the evacuation of the data despite the intention of a user even when the user wants to turn off the power source immediately. Moreover, the technique of Japanese Patent Application Laid-Open Publication No. Hei 7-162624 is to evacuate copying conditions and the like at the time of the occurrence of a trouble, and consequently cannot resume a job from the position where the job was broken when a user operated a sub power source switch to instruct the turning-off of the power source thereof during the execution of the job.

### SUMMARY OF THE INVENTION

It is an object of the present invention to enable a user to perform an operation that the user intends when the user instructs a termination of an operation by instructing a brake of the power source of an image forming apparatus or the like, and to improve the convenience of the image forming apparatus.

In order to achieve the above object, according to a first aspect of the present invention, an image forming apparatus includes:

an image storing section to store input image data;

an image outputting section to form and output an image onto a recording medium based on the image data stored in the image storing section;

a termination instructing section to instruct a termination of an operation;

a display section to display a selection screen for selecting any one of operation items including at least “forcible termination” and “save the current state and termination” when the termination of the operation is instructed on the termination instructing section during an image forming operation in the image outputting section or during a standby state for the image forming operation;

an operation section to select any one of the operation items displayed on the selection screen; and

a control section to control the operation of the image forming apparatus according to the operation item selected on the operation section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing the functional configuration of an image forming apparatus 1 according to the present invention;

FIG. 2 is a block diagram showing a configuration example of an image storing section 162 of FIG. 1;

FIG. 3 is a flowchart showing stopping processing executed by a control section 11 of FIG. 1;

FIG. 4 is a view showing an example of a thee-selection-item displaying screen 131 displayed on a display section 13 of FIG. 1;

FIG. 5 is a diagram showing an example of data storage of a HDD management table T1 stored in a HDD managing table region 171 of FIG. 1;

FIG. 6 is a flowchart showing restoration processing executed by the control section 11 of FIG. 1; and

FIG. 7 is a view showing an example of a restoration inquiring screen 132 displayed on the display section 13 of FIG. 1.

### DETAILED DESCRIPTION OF THE PREFERRED EMBODIMENTS

In the following, the preferred embodiments of the present invention are described in detail with reference to the attached drawings.

First, the configuration thereof is described.

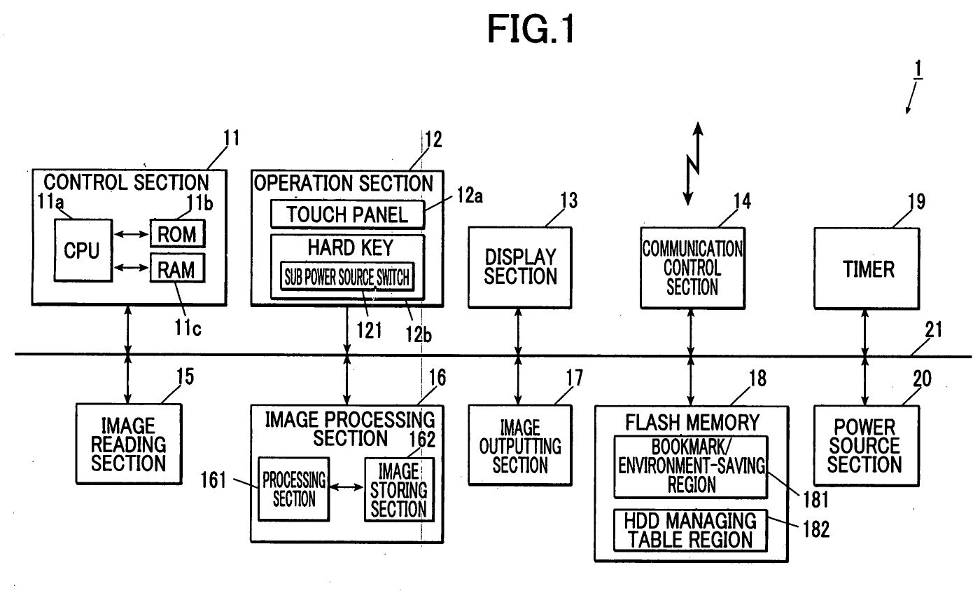

FIG. 1 shows an example of the functional configuration of an image forming apparatus 1 according to the present invention. The image forming apparatus 1 is, for example, an electrophotographic printing system copier, and is composed of a control section 11, an operation section 12, a display section 13, a communication control section 14, an image reading section 15, an image processing section 16, an image outputting section 17, a flash memory 18, a timer 19, a power source section 20, and the like, as shown in FIG. 1. Each section is mutually connected by a bus 21.

The control section 11 is composed of a central processing unit (CPU) 11a, a read only memory (ROM) 11b, a random access memory (RAM) 11c, and the like. The CPU 11a of the control section 11 reads a system program, a wholly controlling program, and various processing programs that are stored in the ROM 11b according to an operation of the operation section 12, and expands the read programs in the RAM 11c. Then, the CPU 11a performs the centralized control of the operation of each section of the image forming apparatus 1 in accordance with the expanded programs.

That is, the CPU 11a receives requests of various kinds of processing input from the operation section 12 or the communication control section 14, and registers the received requests as image forming jobs (hereinafter referred to as jobs). The CPU 11 controls the image outputting section 17 and the like on the basis of the registered jobs, and executes image forming operations (including the formation and the ejection (output) of images onto recording media). To execute a series of operations related to image formation on the basis of a registered job is called as the execution of the job here. Moreover, a state of waiting for the execution of a registered job is called as a standby state for a job. Moreover, a job waiting for the execution thereof (during a standby) among the registered jobs is called as a reserved job.

A job includes job data and the image data of an original, and is given a job ID for identifying the job in the order of the registration thereof by the CPU 11a to be managed. The job data is the data composed of a job ID for identifying the job, various output conditions (a number of pages of the original, a number of output copies, a type of paper, a paper size, a magnification, one-side printing/both-side printing, and the like), a storage position of the image data, and the like, and the job data is stored in the RAM 11c. Moreover, the CPU 11a counts the number of pages, the number of copies, and the like during outputting by the image outputting section 17 during the execution of a job, and stores the counted numbers into the RAM 11c in association with job IDs.

Moreover, the CPU 11a executes various kinds of processing such as stopping processing, restoration processing, which will be described below, and other pieces of processing in accordance with the programs expanded in the RAM 11c.

The operation section 12 is composed of a touch panel 12a and a hard key 12b.

The touch panel 12a is a pressure sensitive (resistive film pressure type) touch panel in which transparent electrodes are disposed in a reticular pattern so as to cover the top surface of the liquid crystal display (LCD) of the display section 13. In the touch panel 12a, the X-Y coordinates of a power point that is pushed down with a finger, a touch pen, or the like are detected as voltage values, and the detected position signal is output as an operation signal to the control section 11. Incidentally, the touch panel is not limited to the pressure sensitive one, but may be other electrostatic and optical ones.

The hard key 12b is equipped with various operation buttons, such as numeral buttons and a start button (not shown), and various operation switches, such as a sub power source switch 121 as a termination instructing section. The hard key 12b outputs an operation signal generated by a button operation or a switch operation to the control section 11. The sub power source switch 121 is a switch for instructing the application of electric power to each section of the image forming apparatus 1 to the control section 11 (by turning on the sub power source switch 121), and for instructing the break of electric power to each section of the image forming apparatus 1 (by turning off the sub power source switch 121).

The display section 13 is composed of an LCD and the like, and displays various operation buttons, the states of devices, the operation situation of each function, and the like on its display screen in accordance with the instructions of display signals input from the control section 11.

The communication control section 14 is an interface connectable with transmission media connected to communication network, such as a local area network (LAN) and a wide area network (WAN). The communication control section 14 is composed of a communication controlling card, such as a LAN card, and performs the transmission and the reception of various kinds of data such as control signals and printer codes with an external device, such as a host device, which is connected to the communication network through a communication line, such as a LAN cable.

The image reading section 15 is composed of a sheet of contact glass, on which an original is placed, and a scanner provided below the contact glass, and reads the image of the original. The scanner is composed of a light source, a charge coupled device (CCD), and the like, and focuses the reflected light of a light that has radiated from the light source to the original and has scanned the original to form an image. The scanner then performs the photoelectric conversion of the focused light to read the image of the original. Furthermore, the scanner converts the read image into digital image data with an A/D converter to output the digital image data to the image processing section 16. The image is not limited to the image data such as a figure and a photograph here, but also includes text data such as a character and a mark, and the like.

The image processing section 16 is composed of a processing section 161 and an image storing section 162. The image processing section 16 performs the image processing, such as spatial filtering processing, enlargement/reduction processing, rotation processing, and tone correction processing, to the image data input from the image reading section 15 in the processing section 161, and temporarily stores the processed image data into the image storing section 162 to output the stored image data to the image outputting section 17 at a predetermined timing. Moreover, the image processing section 16 converts the printer codes input from the communication control section 14 into image data, and temporarily stores the converted image data into the image storing section 162 to output the image data to the image outputting section 17 at a predetermined timing. Incidentally, the input image data is given an image ID to identify the image data. The image data is managed on the basis of the image ID.

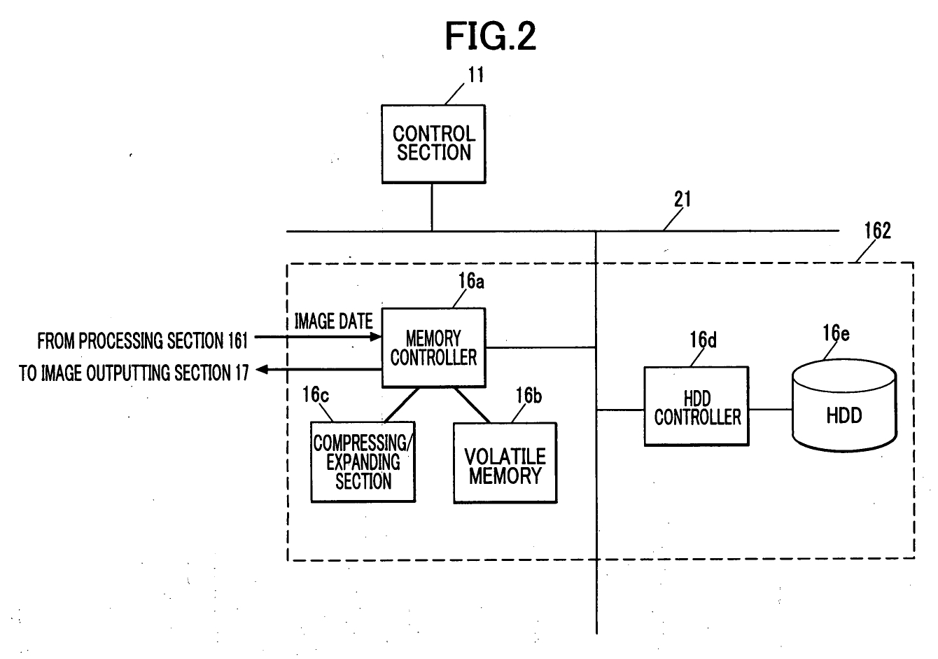

FIG. 2 shows an example of the configuration of the image storing section 162. As shown in FIG. 2, the image storing section 162 is composed of a memory controller 16a, a volatile memory 16b, a compressing/expanding section 16c, a hard disk drive (HDD) controller 16d, and a HDD 16e.

The memory controller 16a performs the writing of the image data input from the processing section 161 into the volatile memory 16b and the reading of image data from the volatile memory 16b under the control of the control section 11. That is, the memory controller 16a makes the compressing/expanding section 16c compress the image data input from the processing section 161, and writes the compressed image data into the volatile memory 16b to make the volatile memory 16b temporarily store the image data under the control of the control section 11. Moreover, when the memory controller 16a receives an instruction to output image data from the control section 11, the memory controller 16a makes the compressing/expanding section 16c expand the image data that is stored in the volatile memory 16b and has been instructed to be output, and outputs the expanded image data to the image outputting section 17.

The volatile memory 16b is composed of a dynamic random access memory (DRAM) or the like. The volatile memory 16b temporarily stores the image data that has been input from the processing section 161 and has been compressed by the compressing/expanding section 16c. The compressing/expanding section 16c is an integrated circuit (IC) to perform the compression processing and the expanding processing of image data.

The HDD controller 16d performs the writing of image data into the HDD 16e, the reading of image data from the HDD 16e, and the deleting of image data from the HDD 16e under the control of the control section 11.

The HDD 16e is nonvolatile storage means to store image data.

The image outputting section 17 of FIG. 1 is a device to form an image on a recording medium on the basis of the image data input from the image processing section 16 and to output the image formed on the recording medium. The image outputting section 17 is composed of a pulse width modulator, a laser light source, a photosensitive drum, a charging device, a developing device, a transferring section, a paper feeding section, a paper ejecting section, a fixing device, and the like. The image outputting section 17 performs the pulse width modulation of the image data input from the image processing section 16 with the pulse width modulator to emit a laser light, and radiates the laser light to the surface of the photosensitive drum, which is charged by the charging device, to form an electrostatic latent image. Furthermore, the image outputting section 17 conveys a recording medium having a size and a direction that are input and instructed from the operation section 12 or the communication control section 14 from the paper feeding section, and the image outputting section 17 makes toner adhere in a region including the electrostatic latent image of the surface of the photosensitive drum with the developing device. The image outputting section 17 makes the transferring section transfer the toner on a conveyed recording medium, and makes the fixing device fix the transferred toner. After that, the image outputting section 17 ejects the recording medium from the paper ejecting section.

The flash memory 18 is nonvolatile storage means for saving the data that is stored in the volatile RAM 11c and indicates the present situation of a job in order that, when the sub power source switch 121 is operated to turn off the sub power source during the execution of the job or during the standby state for the job, the job during the execution thereof or during the standby state thereof can be executed continually when the sub power source is turned on. The flash memory 18 includes a bookmark/environment-saving region 181, a HDD managing table region 182, and the like as shown in FIG. 1. The bookmark/environment-saving region 181 is a region for saving the data that is stored in the RAM 11c and indicates the present situation, i.e., the registered job data; the job ID of the job during execution; counted values (the number of output copies and the number of pages); and the like. (Hereinafter they will be referred to as bookmark/environment information wholly. The bookmark/environment information is the information indicating from which page in which copy of what job an image forming operation is restarted under what output conditions when the sub power source is turned on.) The HDD managing table region 182 is a region for saving a HDD management table T1 for managing the image data saved in the HDD 16e.

The timer 19 is a real time clock (RTC) circuit having a battery therein, and generates a pulse when a time set by the control section 11 arrives to output the generated pulse to the control section 11.

The power source section 20 is connected to a not-shown commercial alternating-current power source, and converts the electric power of the alternating-current (AC) power source input from the commercial alternating-current power source into the electric power of a direct-current (DC) power source to supply a necessary voltage to each section. The power source section 20 supplies electric power in accordance with a control instruction from the control section 11. The connection between the power source section 20 and the commercial alternating-current power source can be turned on and off by the master electrical switch (not shown).

Next, the operation of the present embodiment is described.

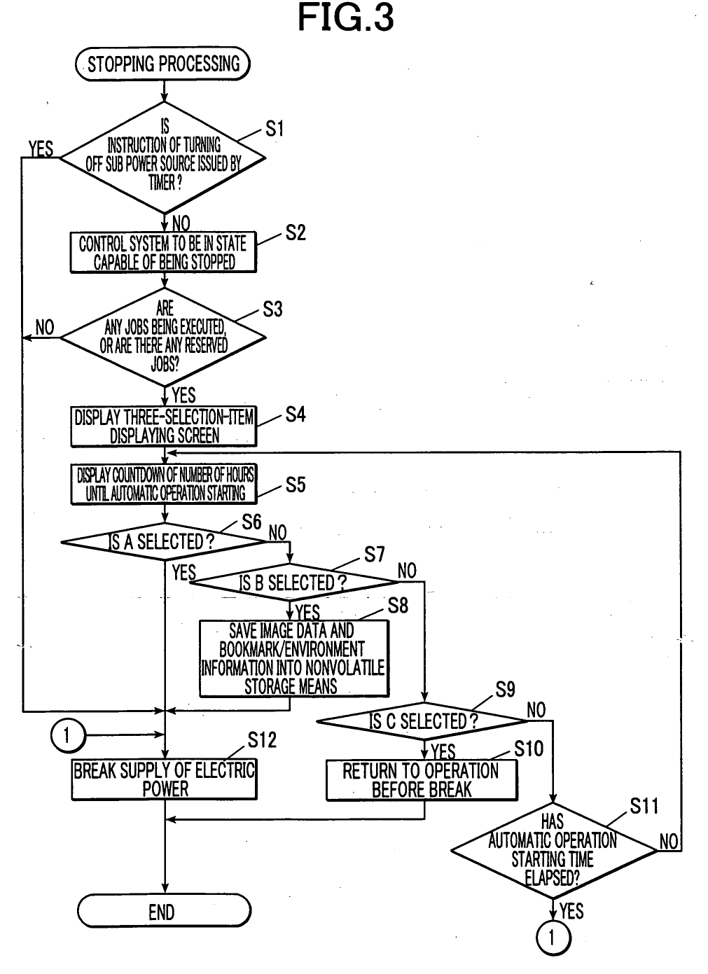

FIG. 3 is a flowchart showing the stopping processing executed by the control section 11 when the turning-off of the sub power source is instructed. The instruction to turn off the sub power source is performed by an input of an operation signal from the sub power source switch 121 or an input of a pulse instructing to turn off the sub power source from the timer 19 generated by the arrival of the time of turning off the sub power source, which time is set in the timer 19. The processing is realized by the software processing by the cooperation of the CPU 11a and the programs stored in the ROM 11b.

It is first judged whether the instruction to turn off the sub power source has been generated by the timer 19 or not. If it is judged that the instruction has been generated by the timer 19 (step S1; YES), then the processing moves to step S12. At step S12, the supply of electric power to each section of the image forming apparatus 1 by the power source section 20 is broken (the turning-off of the sub power source), and the present processing is terminated.

If it is judged that the instruction to turn off the sub power source has not been generated by the timer 19 (step S1; NO), the system is controlled to be in a stoppable state, and the operation thereof is broken (step S2). For example, if a job is being executed, the recording medium on a conveyance pathway in the image outputting section 17 is ejected, and the job is broken.

Next, it is judged whether a job is presently being executed or whether there is a reserved job. If it is judged that neither any jobs are presently being executed nor there are any reserved jobs (step S3; NO), the processing moves to step S12. At step S12, the supply of electric power to each section of the image forming apparatus 1 is broken (the sub power source is turned off), and the present processing is terminated.

If it is judged that a job is presently being executed or there is a reserved job (step S3; YES), a thee-selection-item displaying screen 131 is displayed on the display screen of the display section 13 (step S4). Then, the number of hours (the number of seconds here) until a predetermined automatic operation starting time is counted down, and the number of hours until the predetermined automatic operation starting time is displayed on the thee-selection-item displaying screen 131 in the form of being counted down (step S5). Incidentally, the automatic operation is “A. Forcible Termination” here.

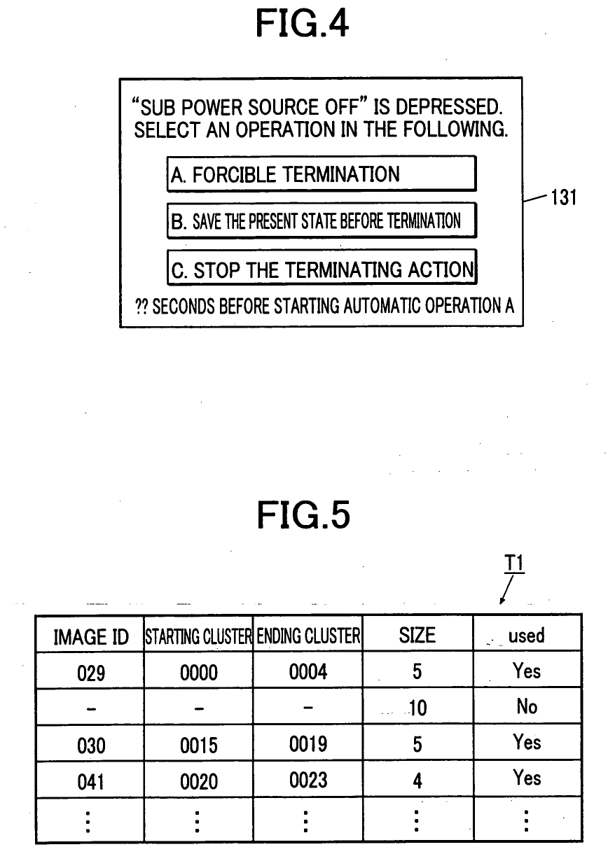

FIG. 4 shows an example of the thee-selection-item displaying screen 131 to be displayed on the display screen of the display section 13 at step S4. As shown in FIG. 4, the thee-selection-item displaying screen 131 is a screen for enabling a user to select a subsequent operation when the turning-off of the sub power source is instructed by an operation of the sub power source switch 121. To put it concretely, the three-selection-item displaying screen 131 is a screen for displaying three operation items of “A. Forcible Termination,” “B. Save the Present State Before Termination,” and “C. Stop the Terminating Action” thereon, and for allowing a user to perform a selection operation of any one of the operation items A-C by a push-down operation of the touch panel 12a at the selected item of the displayed operation items. It can be considered that a user would operate the sub power source switch 121 when the user wants to break the power source immediately, when the user wants to stop the operation of a job of a massive number of copies on that day and wants to resume the job from the broken page on the next day, and when the user operates the sub power source switch 121 by mistake. When the user selects the item A, the supply of electric power is immediately broken. When the user selects the item B, the supply of the electric power is broken after the image data stored in the volatile memory 16b and the bookmark/environment information stored in the RAM 11c have been evacuated into nonvolatile storage means, such as the HDD 16e or the flash memory 18, and have been saved therein. When the user selects the item C, the operation before a brake is resumed. In the lower part of the thee-selection-item displaying screen 131, the number of hours until a start of the automatic operation is displayed in the way of being counted down.

When the item “A. Forcible Termination” is selected on the thee-selection-item displaying screen 131 (step S6; YES), the supply of electric power from the power source section 20 to each section of the image forming apparatus 1 is broken (step S12), and the present processing is terminated.

When the item “B. Save the Present State Before Termination” is selected on the thee-selection-item displaying screen 131 (step S6; NO, step S7; YES), the image data that is temporarily stored in the volatile memory 16b is evacuated into the HDD 16e, and the bookmark/environment information that is stored in the RAM 11c is evacuated into the flash memory 18 (step S8). That is, the image data that is temporarily stored in the volatile memory 16b is sequentially transferred to the HDD 16e and is written therein. Moreover, the bookmark/environment information that is stored in the RAM 11c is transferred to the bookmark/environment-saving region 181 of the flash memory 18 and is written therein.

In order to perform the writing of image data into the HDD 16e and the reading of image data from the HDD 16e at a high speed, the image data for one sheet is written into successive clusters (successive regions) when the image data is written into the HDD 16e in the present embodiment. Moreover, the HDD management table T1 is produced and is written into the HDD managing table region 182 of the flash memory 18 in order to make it possible to survey the fact of what image data has been evacuated into which region of the HDD 16e.

FIG. 5 shows an example of the HDD management table T1. As shown in FIG. 5, the HDD management table T1 stores image IDs for specifying images, and the numbers of starting clusters and the numbers of ending clusters of the successive regions in which the image data specified severally by the image IDs in association with each other.

When the evacuation of the image data that is temporarily stored in the volatile memory 16b and the bookmark/environment information that is stored in the RAM 11c has been completed, the supply of the electric power to each section of the image forming apparatus 1 by the power source section 20 is broken (step S12), and the present processing is terminated.

If the “C. Stop the Terminating Action” is selected on the thee-selection-item displaying screen 131 (step S7; NO, step S9; YES), the processing returns to the operation before the break (step S10), and the present processing is terminated. That is, if a job is being executed, then the broken job is resumed from the time point of the break on the basis of the job data and the bookmark/environment information that are stored in the RAM 11c. If a reserved job is on standby for the execution thereof, then the execution of the reserved job is put on standby.

If any of the operations A-C is not selected from the thee-selection-item displaying screen 131 (step S9; NO), then it is judged whether the automatic operation starting time has elapsed or not. If it is judged that that the automatic operation starting time has not elapsed (step S11; NO), the processing returns to step S5. If it is judged that the automatic operation starting time has elapsed (step S11; YES), then the supply of electric power to each section of the image forming apparatus 1 by the power source section 20 is broken (step S12), then the present processing is terminated.

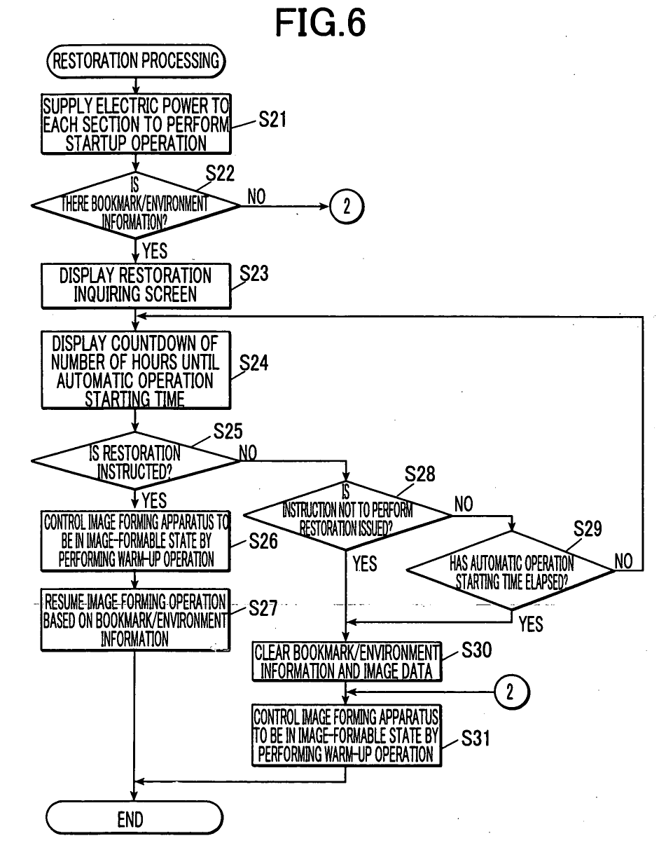

Next, the restoration processing to be executed by the control section 11 when it is instructed to turn on the sub power source is described. FIG. 6 is a flowchart showing the restoration processing. The instruction to turn on the sub power source is performed by an input of an operation signal to turn on the sub power source from the sub power source switch 121, or by an input of an instruction pulse to turn on the sub power source from the timer 19 by the arrival of a sub power source turning-on time set in the timer 19. The processing is realized by the software processing by the cooperation of the CPU 11a and a program stored in the ROM 11b.

First, electric power is supplied to each section of the image forming apparatus 1 by the power source section 20, and a startup operation is performed (step S21). As the startup operation, a wholly controlling program is read from the ROM 11b by a boot program, and is loaded into the RAM 11c. Next, the wholly controlling program is executed, and the connection confirmation and the initialization of the hardware of each section are performed.

Next, the bookmark/environment-saving region 181 of the flash memory 18 is referred to, and it is judged whether any data is stored or not. If it is judged that no data is stored in the bookmark/environment-saving region 181 (step S22; NO), the processing moves to step S31. At step S31, a warm-up operation of the fixing device of the image outputting section 17 and the like are performed, and thereby the system is controlled to be in an image-formable state. Then, the present processing is terminated.

If it is judged that data is stored in the bookmark/environment-saving region 181 (step S22; YES), then a restoration inquiring screen 132 to inquire whether to perform or not the restoration of an operation broken while the sub power source has been turned off is displayed (step S23), and a predetermined number of hours (a number of seconds here) is counted down as a standby time until a start of the automatic operation. Moreover, the time until the start of the automatic operation is displayed on the restoration inquiring screen 132 while being counted down (step S24). Incidentally, the broken job is not restored here, but the job registered during the brake is cleared, in the automatic operation. Then, the processing moves to the warm-up operation.

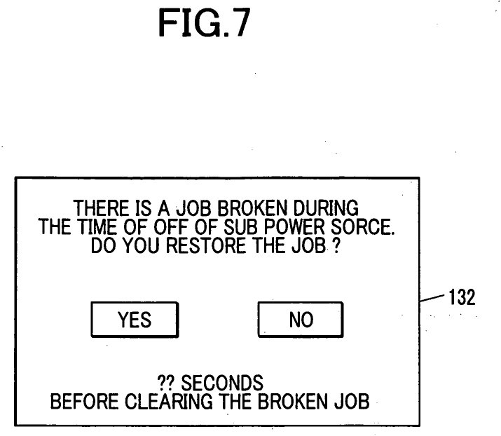

FIG. 7 shows an example of the restoration inquiring screen 132 to be displayed on the display screen of the display section 13 at step S23. As shown in FIG. 7, the restoration inquiring screen 132 is a screen for allowing a user to instruct whether to perform or not the restoration of the operation broken while the sub power source has been off. The restoration inquiring screen 132 displays a message such as “There is a job broken during the time of off of the sub power source. Do you restore the job?,” a “Yes” button for instructing the restoration, and a “No” button for instructing not to perform the restoration. The restoration instruction can be input by a push-down operation of the touch panel 12a on the displayed “Yes” button. Moreover, the not-restoration instruction can be input by a push-down operation of the touch panel 12a on the displayed “No” button. The time until a start of the automatic operation is displayed while being counted down in the lower part of the restoration inquiring screen 132.

If the “Yes” button is pushed down and the restoration is instructed from the restoration inquiring screen 132 by the automatic operation starting time (step S25; YES), a warm-up operation of the fixing device and the like are performed in the image outputting section 17, and the system is controlled to be in the image-formable state (step S26). Then, the bookmark/environment information and the HDD management table T1, which are stored in the bookmark/environment-saving region 181 of the flash memory 18, are read in the RAM 11c, and the image data of the job, the operation of which has been broken before the break of the power supply, in the broken number of pages of the broken number of copies is read from the HDD 16e on the basis of the read bookmark/environment information. Then, an image forming operation (job) is resumed (step S27).

If the “No” button has been pushed down and the intention of not performing restoration has been instructed from the restoration inquiring screen 132 by the automatic operation starting time (step S25; NO, step S28; YES), or if the automatic operation starting time has elapsed (step S28; NO, step S29; YES), then the bookmark/environment information and the HDD management table T1, which are stored in the flash memory 18, are cleared, and the job is thereby cleared (step S30). Then, the warm-up operation of the fixing device and the like are performed in the image outputting section 17, and the system is controlled to be in the image-formable state (step S31). The present processing is then terminated.

As described above, the image forming apparatus 1 displays the thee-selection-item displaying screen 131 for selecting any one of the three items of the “Forcible Termination,” the “Save the Present State Before Termination,” and “Stop the Terminating Action” is displayed on the display section 13 when a break of the power source is instructed by the sub power source switch 121 during the execution of a job or during a standby state for a job under the condition in which the reserved job is registered. When any one of the operation items is selected by an operation of the touch panel 12a, the operation of the image forming apparatus 1 is controlled according to the operation item selected by the selection operation. To put it concretely, if the “Forcible Termination” is selected, the supply of electric power to each section is broken. If the “Save the Present State Before Termination” is selected, the image data stored in the volatile memory 16b and the bookmark/environment information stored in the RAM 11c are saved into the nonvolatile storage means, such as the HDD 16e or the flash memory 18, and then the supply of electric power to each section is broken. When the “Stop the Termination Action” is selected, the operation before the brake is resumed.

Consequently, when a break of the power source is instructed during the execution of a job or during a standby state for a job under the condition in which the reserved job is registered, it becomes possible to perform the “Save the Present State Before Termination” operation or the “Stop the Termination Action” operation besides the “Forcible Termination” operation according to a user's selection operation differently from the prior art, and the operation reflecting the user's intension can be executed. Thus the convenience of the system is improved.

Moreover, when the predetermined automatic operation starting time has elapsed from the display of the thee-selection-item displaying screen 131, the supply of electric power to each section is automatically broken. Consequently, for example, if a user performs no operations to the thee-selection-item displaying screen 131 believing that the user has operated the sub power source switch 121 to break the power source, it can be prevented that the system is left in the state of waiting any input.

Moreover, because the thee-selection-item displaying screen 131 displays the number of hours until an automatic operation starting time in the form of performing a countdown of the number, it is possible to enable the user to recognize the time until the start of an automatic operation, and to prevent the system from moving to the automatic operation suddenly.

Incidentally, the contents of the description of the above embodiment are a suitable example of the image forming apparatus 1 according to the present invention, and the present invention is not limited by the contents.

For example, although the above embodiment is configured to transfer the image data stored in the volatile memory 16b to the HDD 16e and to write the transferred image data into a successive cluster region of the HDD 16e when a break of the supply of electric power to each section is instructed by the sub power source switch 121 as the termination instructing section, the configuration of the termination instructing section is not limited to this one. For example, the configuration may be the one to transfer the image data stored in the volatile memory 16b to the HDD 16e and to write the transferred image data in a successive cluster region of the HDD 16e when the movement to a low power consumption mode is instructed by the operation section 12.

Moreover, although the above embodiment is configured to write the image data for one sheet into successive clusters of the HDD 16e to manage the image data saved in the HDD 16e by means of the HDD management table T1 when the “B. Save the Present State Before Termination” is selected and the image data in the volatile memory 16b is evacuated to be saved, the configuration may be the one to write image data into the HDD 16e in the form of a file to perform file management by means of file allocation tables (FAT).

Moreover, although the above embodiment is configured to automatically move to the forcible termination operation after the elapse of the automatic operation starting time and to break the supply of electric power, the configuration may be the one to enable a user to input a movement destination of the operation among the operations of the “Forcible Termination,” the “Save the Present State Before Termination,” and the “Stop the Termination Action” from the operation section 12 after the elapse of the automatic operation starting time, to set the input operation item into the flash memory 18, and to move the operation to the set one after the elapse of the automatic operation starting time.

Moreover, the configuration may be the one to enable the user to input the time until the automatic operation starting time by means of the operation section 12 to set the input time into the flash memory 18 or the like.

In addition, the configuration and the operation of the details of each device constituting the image forming apparatus 1 also can suitably be changed without departing from the sprit and the scope of the present invention.

According to the embodiment of the present invention, the image forming apparatus includes:

an image storing section to store input image data;

an image outputting section to form and output an image onto a recording medium based on the image data stored in the image storing section;

a termination instructing section to instruct a termination of an operation;

a display section to display a selection screen for selecting any one of operation items including at least “forcible termination” and “save the current state and termination” when the termination of the operation is instructed on the termination instructing section during an image forming operation in the image outputting section or during a standby state for the image forming operation;

an operation section to select any one of the operation items displayed on the selection screen; and

a control section to control the operation of the image forming apparatus according to the operation item selected on the operation section.

Hereby, because it becomes possible to perform the operations such as the “save the present state before termination” according to the selection operation by a user besides the “forcible termination” when a termination of an operation is instructed during the image forming operation or during a standby of the image forming operation unlike the prior art, it becomes possible to perform the operation reflecting the intension of the user, and the convenience of the system is improved.

Moreover, it is preferable that the control section controls the operation of the image forming apparatus according to a predetermined operation item among the operation items displayed on the selection screen when no selection operation item have been selected on the operation section for a predetermined time since the selection screen was displayed on the display section.

Hereby, when no selection operations have been performed from the operation section during the predetermined given time from the time when the selection screen has been displayed, the image forming apparatus automatically moves to the predetermined operation. Consequently, for example, if a user believes that the user has terminated the operation by an instruction of an operation termination with the termination instructing section and has performed no operations from the selection screen, then it is possible to prevent the image forming apparatus from being left in an input waiting state.

Moreover, it is preferable that the control section displays remaining time of the predetermined time on the selection screen of the display section by a countdown.

Hereby, because it is possible to enable a user to recognize a time until a start of the operation according to the predetermined operation item, it becomes possible to prevent a sudden movement to the predetermined operation.

Moreover, it is preferable that an instruction of the termination of the operation by the termination instructing section is an instruction of a breakdown of a power supply.

Hereby, when a break of the power source is instructed during an image forming operation or during a standby of an image forming operation, it becomes possible to perform the operation such as the “save the present state and termination” according to a user's selection operation besides the “forcible termination” operation unlike the prior art. Consequently, it becomes possible to perform the operation reflecting a user's intension, and the convenience of the image forming apparatus is improved.

Incidentally, the entire disclosure of Japanese Patent Application No. 2006-245656 filed on Sep. 11, 2006 including description, claims, drawings, and abstract is incorporated herein by reference in its entirety.

In the above, although various exemplary embodiments have been shown and described, the invention is not limited to the embodiments shown. Therefore, the scope of the invention is intended to be limited solely by the scope of the claims that follow.

What is claimed is:

1. An image forming apparatus comprising:
an image storing section to store input image data;
an image outputting section to form and output an image onto a recording medium based on the image data stored in the image storing section;
a termination instructing section to instruct a termination of an operation;
a display section to display a selection screen for selecting any one of operation items including at least “forcible termination” and “save the current state and termination” when the termination of the operation is instructed on the termination instructing section during an image forming operation in the image outputting section or during a standby state for the image forming operation;
an operation section to select any one of the operation items displayed on the selection screen; and
a control section to control the operation of the image forming apparatus according to the operation item selected on the operation section.

2. The image forming apparatus according to claim 1, wherein the control section controls the operation of the image forming apparatus according to a predetermined operation item among the operation items displayed on the selection screen when no selection operation item have been selected on the operation section for a predetermined time since the selection screen was displayed on the display section.

3. The image forming apparatus according to claim 2, wherein the control section displays remaining time of the predetermined time on the selection screen of the display section by a countdown.

4. The image forming apparatus according to claim 1, wherein an instruction of the termination of the operation by the termination instructing section is an instruction of a break of a power supply.
